(19) United States
(12) Patent Application Publication
(10) Pub. No.: US 2004/0239759 A1
(43) Pub. Date: Dec. 2, 2004

(54) Camera mounted pylon system

(76) Inventor: Gaginda R. Wickramaratna, Marlton, NJ (US)

Correspondence Address: Hollstein Keating Cattell Johnson & Goldstein P.C., Willow Ridge Executive Office Park, Suite 301, 750 Route 73 South, Marlton, NJ, 08053, US

(21) Appl. No.: 10/452,078

(22) Filed: Jun. 2, 2003

(51) Int. Cl. H04N 7/18

(52) U.S. Cl. 348/61

(57) ABSTRACT

A pylon marker made of solid foam or other resiliently compressible material which maintains the shape of the pylon has internal cavity openings into which one or up to four micro-cameras or similar miniature cameras are placed. The cameras take real time images of the action, for instance football players contacting or passing by or in the line of sight of the pylon. One or more transmitters, also located in cavity openings in the pylon, receive the real time image signals from the camera and send those signals to a video receiver and then to a television or VCR, located on the sidelines or other remote location. A battery pack also located in the pylon, provides the electrical power for the cameras. When the pylon markers are positioned at the four corners of the football end zone, images of players contacting or passing the pylon from a number of different angles will constantly be transmitted for immediate view by broadcasters, the public, and, if necessary, football officials.

### BACKGROUND OF THE INVENTION

The tremendous increase in popularity of professional and college football has resulted, in large measure, from the extensive television coverage the sport has received. The use of television, videotape, film and other forms of video, with their visual representations, pictures and other images, has added to the drama, excitement and enjoyment of watching a football game. The manner of presenting such visual images has included the use of video and still photography cameras, capturing the action from many different locations and angles. From what began with a few television cameras on the sidelines or located above the action in the media box, has grown to the use of module, hand-held cameras, cameras being positioned on goal posts and even cameras on players, coaches, and officials. Most recently, overhead cameras have been positioned to show players on the fields from a number of angles, including from behind as plays are run.

However, despite the various angles and positions in which cameras are now placed, there is still no means to provide a firsthand and accurate view of the action in the end zone, as the player crosses the goal line to score a touchdown or to view the end line of the end zone during a play and there is only limited means to provide end zone perspectives.

### BRIEF SUMMARY OF THE INVENTION

It is thus the object of the present invention to offer a camera mounted pylon system which will provide unique, real time views and vantage points of football players in action.

It is an object of the present invention to provide a camera mounted pylon system which is positioned at the corners of the end zone to provide unique, ground level, realtime views of football players crossing the end zone, being chased out of bounds as they reach the corners of the end zone to score a touchdown, and all goal line and sideline action.

It is a further object of the present invention to provide a camera mounted pylon system which provides a miniature camera, actually located on the field, which players have to knock down at the corner of the end zone, to indicate that a touchdown has been scored in that location.

It is another object of the present invention to provide a camera mounted pylon system which provides a camera angle which will capture a football player who is running down the sidelines towards the camera, from a stationary camera already in position.

It is still another object of the present invention to provide a camera mounted pylon system which will eliminate the need for extra cameramen, by providing eight additional stationary camera units on the football field.

It is another object of the present invention to provide a camera mounted pylon system which will assist football officials in making decisions by allowing for additional instant reply angles.

These and other objects are accomplished by the present invention which comprises a pylon marker made of a solid foam or other resiliently compressible material which maintains the shape of the pylon. The pylon has internal cavity openings into which one or up to four micro-cameras or similar miniature cameras are placed. The cameras take real time images of the action, for instance football players contacting or passing by or in the line of sight of the pylon. One or more transmitters, also located in cavity openings in the pylon, receive the real time image signals from the camera and send those signals to a video receiver and ten to a television or VCR, located on the sidelines or other remote location. A battery pack also located in the pylon, provides the electrical power for the cameras. When the pylon markers are positioned at the four corners of the football end zone, images of players contacting or passing the pylon, from a number of different angles will constantly be transmitted for immediate view by broadcasters, the public, and, if necessary, football officials.

The novel features which are considered as characteristic of the invention are set forth in particular in the appended claims. However, both as to their design, construction, and use, together with additional features and advantages thereof, they are best understood upon review of the following detailed description with reference to the accompanying drawings.

### BRIEF DESCRIPTION OF THE DRAWINGS

FIG. 1 is a isometric view of the pylon of the present invention, showing the positioning of its internal components.

FIG. 2 is an isometric view similar to FIG. 1, with the pylon turned 90°

FIG. 3 is a view of the covering of the pylon of the present invention in relation to its internal body portion.

FIG. 4 is a top view of the pylon of the present invention, showing the positioning of internal components.

FIG. 5 is a view of the pylon of the present invention, mounted on the goal line of a football field.

### DETAILED DESCRIPTION OF THE INVENTION

Pylon marker 1 is formed of solid foam or other resiliently compressible material which maintains the shape of the pylon. Body 2 is contained within covering 3, which can be waterproof plastic or similar material. The pylon has internal cavity openings 4, 5, 6, and 7 into which miniature video cameras or micro-cameras 8, 9, 10 and 11 and video signal transmitter 12 are located. Cameras 8, 9, 10 and 11, video or still photography cameras, take real time images of the action. Transmitter 12 receives the real time image signals from the cameras and sends these signals to a video receiver 13, which decodes the signal and then sends the signal to a television or VCR, on the sidelines or other remote location.

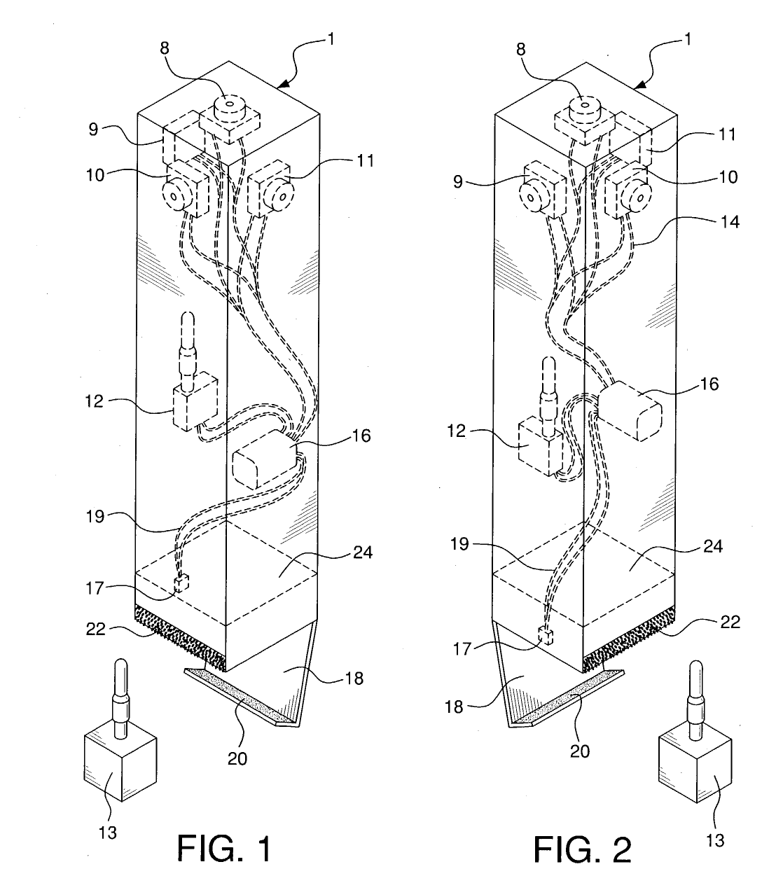

It is contemplated that a single transmitter capable of accepting separate signals from all cameras positioned in the pylon and separately sending those signals to a video receiver, can be used. It is also within the purview of the invention to employ a separate transmitter for each camera, each capable of separately receiving and sending signals. Each such transmitter would be located in the pylon marker. For the sake of simplicity, FIGS. 1-3 show the use of single transmitter 12, but multiple transmitters as described, can be similarly placed within pylon 1, as needed.

Lead wires 14 run from cameras 8, 9, 10 and 11 to battery pack 16, which provides the electrical power for the cameras. Battery pack 16 can be of the rechargeable or non-rechargeable variety. Battery pack 16 is located in cavity opening 15 in pylon 1. Switch 17, connected via head wires 17 to battery pack 16, allows the system to be turned off and on.

Cameras 8, 9, 10 and 11 with battery pack 16, and transmitter 12, in and of themselves are known components in the video industry and are readily adapted for use as elements of the subject invention.

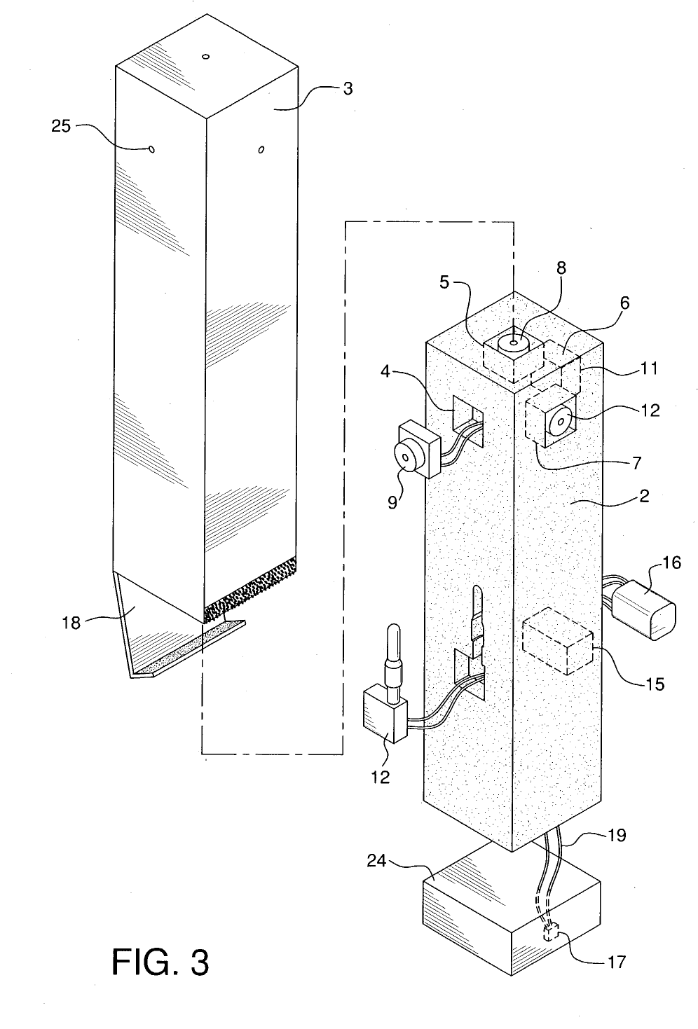

Pylon 1 also has bottom door member 18 which is pivotally opened to provide access to the components located within the pylon, in order to allow for their replacement when necessary. Velcro™ attachments 20 and 22 are used to secure door 18. Weight 24 provides balance and stability at the bottom of pylon 1. Peephole openings, such as are indicated at 25 in FIG. 3, are appropriately located through covering 3, to allow the cameras clear views of the surrounding area.

When components of pylon marker 1 require replacement, container 3 is simply removed from body 2. This allows ready access to body 2. The component to be replaced is removed from its respective cavity and a new component installed.

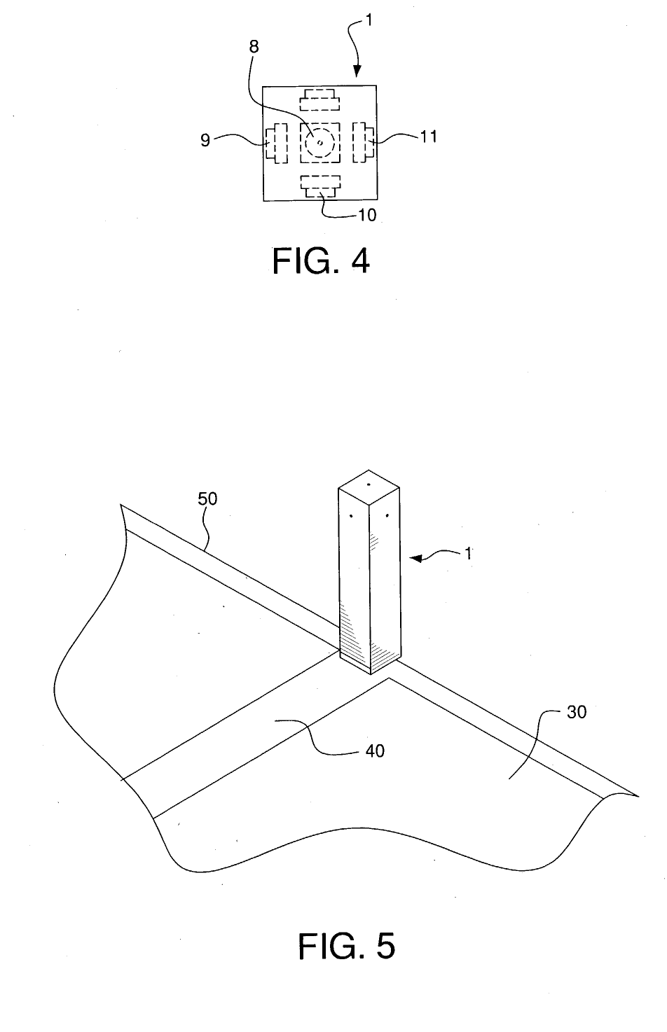

In use, it is contemplated that eight pylons of the subject invention would be placed on a football field, one at each corner of the two end zones of a football field. Generally, football pylons are placed on the corners of the end zone to mark imaginary lines which travel vertically upward and perpendicularly outward from the pylon to guide players and officials as to the bounds of the end zones. For instance, FIG. 4 shows pylon 1 positioned on goal line 40 and sidelines 50 of football field 30.

In the subject invention, multiple cameras may be used in each pylon 1, as appropriate. For instance, locating four cameras in the pylons which are positioned at the goal lines, will provide real time images of events occurring down the sidelines of the field, across the goal lines, at the sidelines of the end zones, and for action which may occur immediately above the pylon. A lesser number of cameras would obviously be required in the pylons at the back of the end zones, where only images within the end zone and over the pylon would be significant.

Use of the novel pylon marker of the subject invention will show real time images when a player hits or passes in the vicinity of the pylon, scoring a touchdown. It will provide a unique view of the ball as it hits the pylon and of the determination of the player as he strains for a touchdown. The pylon of the subject invention can also be used by the football officials both on and off the field, to check the instant replay of images taken, to see if a player breaks the imaginary lines bordering the end zone.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

I claim:

1. A pylon for placement at the corners of a football field end zone, said pylon comprising:
(a) a substantially solid unitary body comprising resiliently compressible material which maintains the shape of the pylon;
(b) camera means for taking real time images of players contacting or passing by or in the line of sight of the pylon, said camera means being positioned within the body;
(c) transmitting means for receiving real time image signals from the camera means and sending those signals to a video receiver, said transmitter means also being positioned within the body;
(d) opening means within the body for receiving and maintaining the camera means and the transmitter means in the body; and
(e) means located in space-relation to the body for providing access to the opening means to permit removal and replacement of the camera means and the transmitter means.

2. The pylon as in claim 1 further comprising means for providing electrical power to the camera means, said power means also being positioned within the body.

3. The pylon as in claim 2 wherein the power means comprises a battery pack.

4. The pylon as in claim 1 wherein the opening means comprises separate cavity openings for receiving and maintaining the camera means and for the transmitter means.

5. The pylon as in claim 2 wherein the opening means comprises a cavity opening for receiving and maintaining the power means.

6. The pylon in claim 1 further comprising a covering which encompasses and contains the body.

7. The pylon as in claim 6 wherein the access means comprises a door member pivotally mounted on the covering.

8. The pylon as in claim 1 wherein the camera means comprises one micro-camera.

9. The pylon as in claim 1 wherein the camera means comprises more than one micro-camera.
